(19) United States
(12) Patent Application Publication
(10) Pub. No.: US 2026/0306973 A1
(43) Pub. Date: Oct. 8, 2026

(54) WATER FILTER PRIMING PUMP

(71) Applicant: James Enterprise Inc., Pueblo, CO (US)

(72) Inventors: Todd Emerson, Pueblo, CO (US); Brad Emerson, Pueblo, CO (US); Gerard Klaes, Moab, UT (US); Parker Emerson, Pueblo, CO (US); Victor Bejar, Charleston, SC (US); Cody Wigner, Pueblo, CO (US); Matt Candrian, Littleton, CO (US); Mitchel Ortiz, Pueblo, CO (US)

(21) Appl. No.: 19/173,552

(22) Filed: Apr. 8, 2025

(51) Int. Cl. B01D 35/16; B01D 29/11; B01D 35/30; B08B 9/035

(52) U.S. Cl. CPC B01D 35/16; B01D 29/11; B01D 35/30; B08B 9/035; B01D 2201/347; B01D 2201/4092; B08B 2209/032

(57) ABSTRACT

A water filter priming pump including a filter cavity with a downward facing opening and a filter connection positioned within the filter cavity. The housing includes a mounting feature positioned to support the housing on a container of water whereby the filter cavity opening is located below a surface of the water. A suction pump having an inlet and an outlet is contained in the housing, wherein the inlet is in fluid communication with the filter connection.

### FIELD OF THE DISCLOSURE

The present disclosure relates to priming gravity-fed water filters, and more particularly to priming gravity-fed water filters with a suction pump.

### BACKGROUND

Gravity-fed water filtration systems use replaceable filter elements, which can be composed of a variety of materials intended to reduce targeted substances found in drinking water, such as PFAS, lead, arsenic, fluoride, and industrial chemicals. Some filters are manufactured into a cylindrical shape with a hollow core or internal cavity. Others have an outer shell made of a solid material such as plastic or metal and are filled with a granulated media. Still others may employ different combinations of shapes and materials.

The common challenge many gravity-fed filters share is that priming is required prior to use. Priming wets the surface of the filter media, enhancing flow, and allowing for purging of any small particulates remaining in the filter from the manufacturing process. An incomplete prime of a filter may result in restricted or uneven flow within the filter, reducing life and leaving visible particulates in the filtered water.

### SUMMARY

In one implementation of the present disclosure, a water filter priming pump includes a filter cavity with a downward facing opening and a filter connection positioned within the filter cavity. The housing includes a mounting feature positioned to support the housing on a container of water whereby the filter cavity opening is located below a surface of the water. A suction pump having an inlet and an outlet is contained in the housing, wherein the inlet is in fluid communication with the filter connection.

In one example of this implementation, the filter connection is axially aligned with the filter cavity. In a second example, the filter connection comprises a female thread connection. In a third example, the water filter priming pump can include a male-to-male thread adapter fitting to engage with the female thread connection and a cylindrical adapter washer positioned on the adapter fitting. The adapter washer can include a central opening shaped to mate with a corresponding feature of the adapter fitting and an axially extending protrusion positioned to engage a corresponding feature of a filter. In a fourth example of this implementation, the housing can include a discharge conduit in fluid communication with the suction pump outlet. In a fifth example, the discharge conduit exits the housing on a side opposite the mounting feature whereby water is discharged into the container. In a sixth example of this implementation, the mounting feature comprises a hook extending from a side of the housing. In a seventh example, the water filter priming pump can include a timer programmed to operate the suction pump for a predetermined amount of time. In an eighth example, the water filter priming pump can include a start/stop button operative to activate and deactivate the suction pump. In a nineth example, the water filter priming pump can include a countdown display indicating remaining time of the predetermined amount of time. In a tenth example, the predetermined amount of time is approximately 90 seconds. In an eleventh example, the suction pump is battery operated. In a twelfth example, the housing includes a water level indicator.

In another implementation of the present disclosure, a method for priming a water filter includes supporting a filter to be primed in a container of water, wherein an upper end portion of the filter is not submerged in the water, and enclosing the upper end portion of the filter between a cover and a surface of the water. The method can include connecting the filter to a suction pump, operating the suction pump to pull water through the filter, and discharging the water pulled through the filter into the container.

In one example of this implementation, the method can include operating the suction pump for a predetermined amount of time and automatically deactivating the suction pump. In a second example of this implementation, the predetermined amount of time is approximately 90 seconds. In a third example, the method can include using an adapter to connect the filter to the suction pump. In a fourth example of this implementation, the adapter comprises a male-to-male thread adapter fitting to engage with female threads on the filter and female threads associated with the suction pump. In a fifth example, the method can include removing the filter from the female threads associated with the suction pump by rotating the adapter fitting counter-clockwise together with the filter. In a sixth example, the method can include positioning a cylindrical adapter washer on the adapter fitting to rotate the adapter fitting together with the filter, wherein the adapter washer includes a central opening shaped to mate with a corresponding feature of the adapter fitting and an axially extending protrusion positioned to engage a corresponding feature of the filter.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is an isometric view from the front of a water filter priming pump according to the disclosed technology;

FIG. 2 is an isometric view from the rear of the water filter priming pump shown in FIG. 1;

FIG. 3 is a bottom view of the water filter priming pump shown in FIGS. 1 and 2;

FIG. 4 is a cross-sectional view of the water filter priming pump taken about line 4-4 in FIG. 3

FIG. 5 is a partially exploded isometric view of a representative primary filter assembly;

FIG. 6 is a partially exploded isometric view of a representative secondary filter assembly;

FIG. 7 is an isometric view of an adapter fitting and adapter washer for use with a secondary filter according to the disclosed technology.

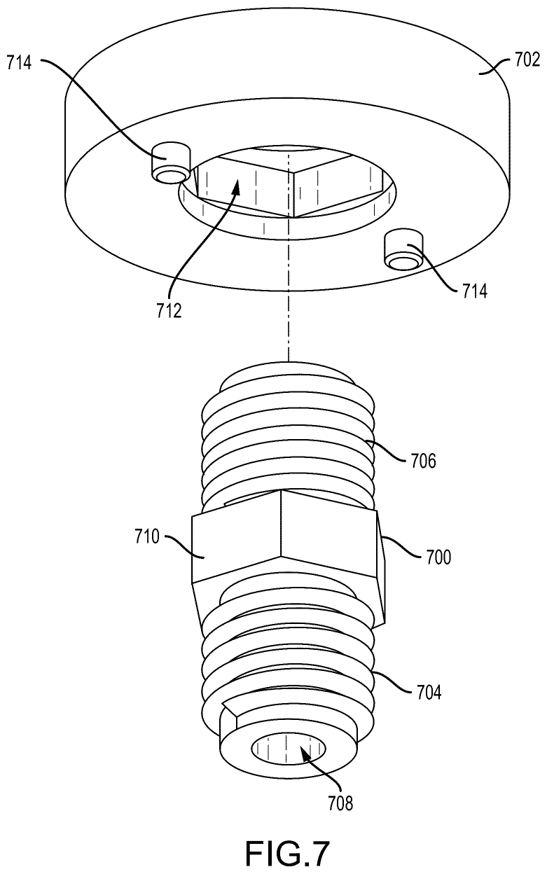

Corresponding reference numerals are used to indicate corresponding parts throughout the several views.

### DETAILED DESCRIPTION

Before any implementations of the disclosure are explained in detail, it is to be understood that the disclosure is not limited in its application to the details of construction and the arrangement of components set forth in the following description or illustrated in the accompanying drawings. The disclosure is capable of supporting other implementations and of being practiced or of being carried out in various ways. Also, it is to be understood that the phraseology and terminology used herein is for the purpose of description and should not be regarded as limiting.

Gravity-fed water filters generally require priming prior to use. Priming wets the surface of the filter media, enhancing flow, and allowing for purging of any small particulates remaining in the filter from the manufacturing process. An incomplete prime of a filter may result in restricted or uneven flow within the filter, reducing life and leaving visible particulates in the filtered water.

The disclosed water filter priming pump is operative to wet all surfaces of the media of the filters being primed. This can be accomplished under pressures of approximately 1 to 2 psi; however, there is a benefit to suction priming with water flow in the opposite direction to intended use, as that most effectively purges debris from the inner cavity of the filter element. As such, the priming pump described herein works via suction.

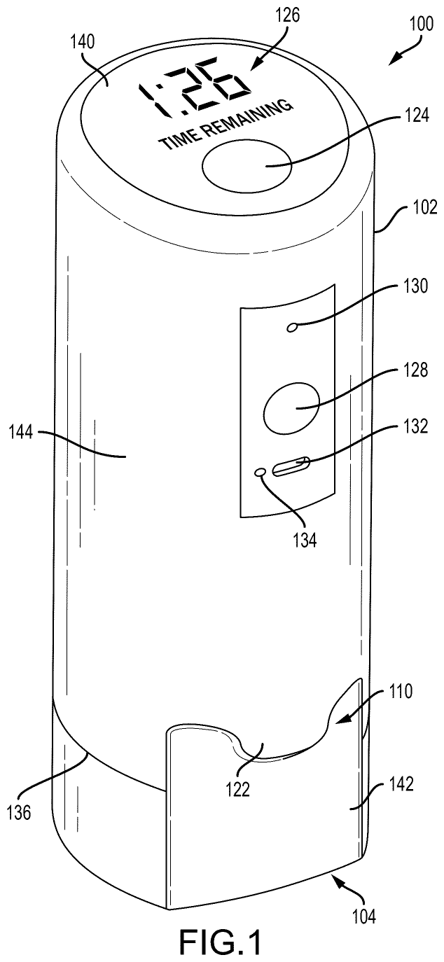

Referring to FIG. 1, an implementation of a water filter priming pump 100 can include a housing 102 having a surrounding sidewall 144 and a top surface 140. The priming pump 100 can include a button 124 to start and stop the priming cycle. In some implementations, the top surface 140 includes a display 126 positioned next to the start/stop button 124 to indicate the remaining time in a purging cycle. The priming pump 100 can also include a power button 128 with a power on/off indicator 130. A charging port 132 (e.g., USB port) and a battery status indicator 134 are positioned near the power button 128. In some implementations, the start/stop button 124, the power on/off indicator 130, the charging port 132, and the battery status indicator 134 are mounted in the sidewall 144 of the housing 102.

The priming pump 100 includes a mounting feature 110 positioned on the housing 102 to support the priming pump 100 on a container filled with water (not shown) whereby the filter cavity opening 104 is located below a surface of the water. In some implementations, the mounting feature 110 is in the form of a hook 122. The hook 122 can be integrally formed e.g., molded with the housing 102 or can be a separate component that is attached to the housing 102 with suitable fasteners. The housing 102 can also include a flat portion 142 to provide stability when the pump 100 is hung on the container with the hook 122. In other implementations, the mounting feature 110 can be a combination of magnets and/or a physical locating feature, for example.

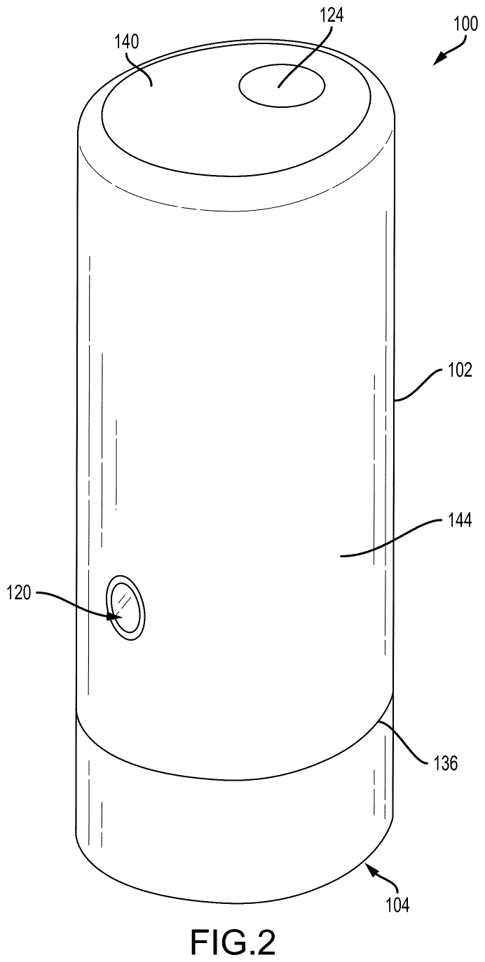

In some implementations, the housing 102 includes a water level indicator 136, e.g., a line molded into the surrounding sidewall 144 of the housing 102, to indicate how much to fill the container. With further reference to FIG. 2, the housing 102 also includes a discharge conduit 120. The discharge conduit 120 exits the housing 102 on a side opposite the mounting feature 110 whereby water is discharged into the container. In other implementations, the discharge conduit 120 can be configured to discharge out of the container. In other words, the discharge conduit 120 can be located on the same side of the housing 120 as the mounting feature 110.

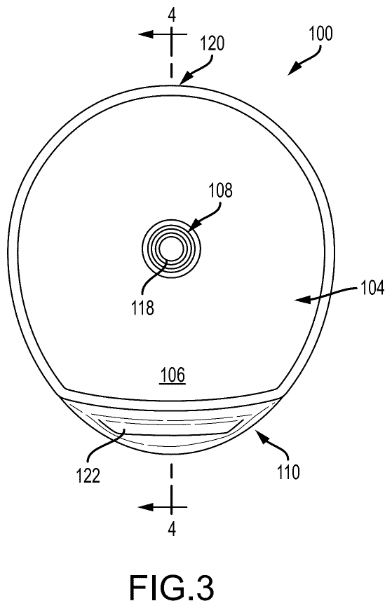

As shown in FIG. 3, the housing 102 includes a filter cavity 106 with a downward facing opening 104. A filter connection 108 is positioned within the filter cavity 106. In some implementations, the filter connection 108 comprises a female thread connection 118. Thus, a filter to be primed can be screwed into the threaded connection 118 of the pump 100, inside the filter cavity 106.

The filter cavity 106 is of a specific length or size, designed specifically to ensure that the filter media is not exposed to air, as the water level in the chamber decreases while the pump 100 fills the cavities of the filter with water during the priming cycle. In one implementation, the filter cavity 106 is approximately 2.64 inches deep and approximately 2.85 inches in diameter, for example. The diameter of the filter cavity 106 is large enough to receive an upper end portion of the filter to be primed.

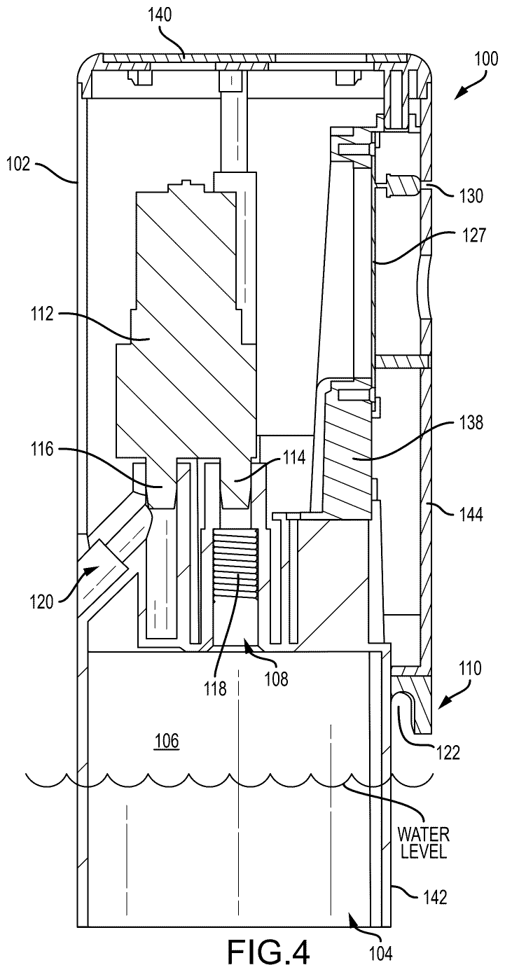

With reference to FIG. 4, the priming pump 100 includes a suction pump 112 positioned inside the housing 102. The suction pump 112 has an inlet 114 and an outlet 116, wherein the inlet 114 is in fluid communication with the filter connection 108. The discharge conduit 120 is in fluid communication with the suction pump outlet 116. The filter connection 108 is axially aligned with the filter cavity 106 and the suction pump inlet 114. The mounting feature 110, e.g., hook 122, facilitates positioning of the pump 100, so that the pump 100 is neither too high nor too low in the container of water during the priming cycle. This helps ensure (1) that adequate water exists to prime the filter, and the filter/pump is not exposed to air during the priming cycle, and (2) pump electronics are not exposed to water.

A timer 127 is located in the housing 102 and programmed to operate the suction pump 112 for a predetermined amount of time. Appropriate priming duration has been established which ensures all internal media surfaces are wetted during the cycle. Priming duration is controlled electronically via a processor inside the pump housing 102. In some implementations, the predetermined amount of time is approximately 90 seconds, or one and a half minutes. Other priming durations may be selected depending on filter type and media, for example. The countdown display 126 indicates the remaining time of the predetermined amount of time. In some implementations, the priming pump 100 is battery operated and includes a battery 138 mounted in the housing 102.

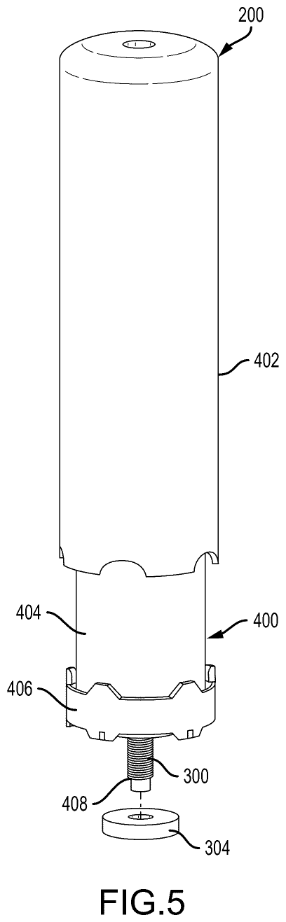

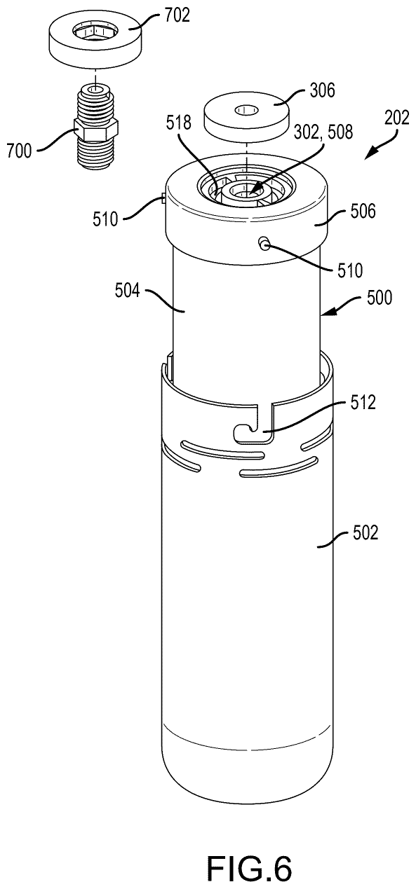

Referring to FIGS. 5 and 6, examples of two different types of filters suitable for priming are described. A gravity-fed water filter system can include a primary filter assembly 200 positioned in a primary container (not shown) and a secondary filter assembly 202, positioned in a secondary container (not shown), in fluid communication with the primary filter assembly 200. In some implementations, the primary filter assembly 200 reduces a wide variety of contaminants as the water to be filtered flows from the primary container through the primary filter assembly 200. The water flows from the primary filter assembly 200 into the secondary filter assembly 202 where it is further filtered as it flows through the secondary filter assembly 202 and into the secondary container for collection and subsequent consumption. Both the primary and secondary filters can benefit from priming before use.

The primary filter assembly 200 and the secondary filter assembly 202 screw together with mating male and female threads, 300 and 302, respectively. Both filter assemblies seal against the bottom of the primary container with rubber washers 304 and 306, for example. The primary filter assembly 200 seals against a top side of the primary container bottom and the secondary filter assembly 202 seals against a bottom side of the primary container bottom.

With specific reference to FIG. 5, the primary filter assembly 200 includes a primary filter 400 and a shell 402 surrounding the sides and top of the primary filter 400. The primary filter 400 includes a cylindrical body 404 surrounding an internal cavity (not visible). The cylindrical body 404 is a filter element that can include activated carbon, for example. The primary filter 400 can include a cap 406 secured to a lower end portion of the cylindrical body 404. The primary filter 400 includes a stem 408 in fluid communication with the internal cavity of the primary filter 400. The stem 408 extends from the bottom of the primary filter 400 (i.e., extends from the cap 406). To prime the primary filter 400, the filter is turned so that the stem 408 is pointing upward and the threads 300 are screwed into the priming pump filter connection 108 to engage the female thread connection 118. Rubber washer 304 seals between the cap 406 and the housing 102. The upper end, i.e., cap 406, is thereby positioned in the filter cavity 106. Note, the shell 402 is set aside during the priming procedure.

With further reference to FIG. 6, the secondary filter assembly 202 includes a secondary filter 500 and a shell 502 surrounding the sides and bottom of the secondary filter 500. The secondary filter 500 includes a cylindrical body 504 surrounding an internal cavity (not shown). In some implementations, the cylindrical body 504 is a filter element that can include activated carbon, for example. The secondary filter 500 can include a cap 506 secured to an upper end portion of the cylindrical body 504. The cap 506 includes an inlet 508 in fluid communication with the internal cavity of the secondary filter 500. In some implementations, the inlet 508 can include female threads 302 extending at least partially through the cap 506.

In some implementations, the shell 502 is removably attached to the secondary filter 500. The secondary filter 500 and the shell 502 are cylindrical, the secondary filter includes a radially extending protrusion 510, and the shell 502 includes a groove 512 positioned to engage the protrusion 510 and secure the shell 502 to the secondary filter 500.

In some implementations, the pump 100 and/or the secondary filter assembly 202, and/or the secondary filter 500 can be provided with adapters 700/702 to facilitate connecting the secondary filter 500 to the priming pump 100. For example, the adapters can include a male-to-male thread adapter fitting 700 to engage with the female threads 302 of the secondary filter 500. The adapter fitting 700 also has a fluid passage 708 extending axially therethrough. The adapter fitting 700 can include a first set of threads 704 sized and configured to mate with the threads 302 of the secondary filter 500 and a second set of threads 706 to screw into the priming pump filter connection 108 to engage the female thread connection 118.

The adapter fitting 700 can work in conjunction with a cylindrical adapter washer 702 positioned on the adapter fitting 700. The adapter washer 702 includes a central opening 712 shaped to mate with a corresponding feature 710 of the adapter fitting 700. For example, the adapter fitting 700 can include a hexagonal shaped portion 710 that mates with the central opening 712. Axially extending protrusions 714 (e.g., pins or posts) are positioned to engage a corresponding feature 518 of the secondary filter 500. The adapter washer 702 helps ensure that the adapter fitting 700 remains with the secondary filter 500 when the filter is unscrewed from the priming pump 100. The hexagonal shaped portion 710 and the mating central opening ensure that the adapter fitting 700 and the cylindrical adapter washer 702 rotate together. The protrusions 714 engage with the secondary filter 500 ensuring that both the adapter washer 702 and adapter fitting 700 rotate with the secondary filter 500.

Also disclosed herein are methods for priming a water filter. In some implementations, the method can include supporting a filter to be primed in a container of water, wherein an upper end portion of the filter, e.g., 406, 506, is not submerged in the water. The upper end portion of the filter is enclosed between a cover, e.g., filter cavity 106, and a surface of the water and connected to a suction pump 112. In other implementations, the entire filter including the upper end portion of the filter, e.g., 406, 506, is submerged in water during priming. The method includes operating the suction pump 112 to pull water through the filter and discharging, e.g., via outlet 116 and discharge conduit 120, the water pulled through the filter into the container. The method can include operating the suction pump 112 for a predetermined amount of time and automatically deactivating the suction pump 112.

In some implementations, the method can include using an adapter 700 to connect the filter 500 to the suction pump 112. The adapter 700 can include a male-to-male thread adapter fitting 700 to engage with female threads 302 on the filter and female threads 118 associated with the suction pump 112. The method can include removing the filter 500 from the female threads 118 associated with the suction pump 112 by rotating the adapter fitting 700 counter-clockwise together with the filter 500. The method can also include positioning a cylindrical adapter washer 702 on the adapter fitting 700 to rotate the adapter fitting 700 together with the filter 500, wherein the adapter washer 702 includes a central opening 712 shaped to mate with a corresponding feature 710 of the adapter fitting 700 and an axially extending protrusion 714 positioned to engage a corresponding feature 518 of the filter 500.

Although the disclosed priming pump 100 has been described with respect to a suction pump/configuration, a pressure pump/configuration is also possible with the disclosed technology. Furthermore, the pump 100 has been described with particular filter configurations, other filter configurations can be used with the priming pump 100. Moreover, different adapters can be provided to facilitate connection a variety of different filter designs.

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. A water filter priming pump, comprising:
a housing including:
a filter cavity with a downward facing opening;
a filter connection positioned within the filter cavity; and
a mounting feature positioned to support the housing on a container of water whereby the filter cavity opening is located below a surface of the water; and
a suction pump having an inlet and an outlet contained in the housing, wherein the inlet is in fluid communication with the filter connection.

2. The water filter priming pump of claim 1, wherein the filter connection is axially aligned with the filter cavity.

3. The water filter priming pump of claim 2, wherein the filter connection comprises a female thread connection.

4. The water filter priming pump of claim 3, further comprising:
a male-to-male thread adapter fitting to engage with the female thread connection; and
a cylindrical adapter washer positioned on the adapter fitting, wherein the adapter washer includes: a central opening shaped to mate with a corresponding feature of the adapter fitting; and an axially extending protrusion positioned to engage a corresponding feature of a filter.

5. The water filter priming pump of claim 1, wherein the housing includes a discharge conduit in fluid communication with the suction pump outlet.

6. The water filter priming pump of claim 5, wherein the discharge conduit exits the housing on a side opposite the mounting feature whereby water is discharged into the container.

7. The water filter priming pump of claim 1, wherein the mounting feature comprises a hook extending from a side of the housing.

8. The water filter priming pump of claim 1, further comprising a timer programmed to operate the suction pump for a predetermined amount of time.

9. The water filter priming pump of claim 8, further comprising a start/stop button operative to activate and deactivate the suction pump.

10. The water filter priming pump of claim 8, further comprising a countdown display indicating remaining time of the predetermined amount of time.

11. The water filter priming pump of claim 8, wherein the predetermined amount of time is approximately 90 seconds.

12. The water filter priming pump of claim 1, wherein the suction pump is battery operated.

13. The water filter priming pump of claim 1, wherein the housing includes a water level indicator.

14. A method for priming a water filter, comprising:
supporting a filter to be primed in a container of water, wherein an upper end portion of the filter is not submerged in the water;
enclosing the upper end portion of the filter between a cover and a surface of the water;
connecting the filter to a suction pump;
operating the suction pump to pull water through the filter; and
discharging the water pulled through the filter into the container.

15. The method of claim 14, further comprising operating the suction pump for a predetermined amount of time and automatically deactivating the suction pump.

16. The method of claim 14, wherein the predetermined amount of time is approximately 90 seconds.

17. The method of claim 14, further comprising using an adapter to connect the filter to the suction pump.

18. The method of claim 17, wherein the adapter comprises a male-to-male thread adapter fitting to engage with female threads on the filter and female threads associated with the suction pump.

19. The method of claim 18, further comprising removing the filter from the female threads associated with the suction pump by rotating the adapter fitting counter-clockwise together with the filter.

20. The method of claim 19, further comprising positioning a cylindrical adapter washer on the adapter fitting to rotate the adapter fitting together with the filter, wherein the adapter washer includes: a central opening shaped to mate with a corresponding feature of the adapter fitting; and an axially extending protrusion positioned to engage a corresponding feature of the filter.
